(19) United States
(12) Patent Application Publication
(10) Pub. No.: US 2012/0079909 A1
(43) Pub. Date: Apr. 5, 2012

(54) Control Lever Saver

(75) Inventor: Keith Robert Rovell, Houston, TX (US)

(73) Assignee: Keith Robert Rovell, Houston, TX (US)

(21) Appl. No.: 13/200,681

(22) Filed: Sep. 28, 2011

Related U.S. Application Data
(60) Provisional application No. 61/404,310, filed on Oct. 1, 2010.

(51) Int. Cl. G05G 1/04

(52) U.S. Cl. 74/523

(57) ABSTRACT

An apparatus used to quickly, and without additional tools or adhesives, allow anyone to, without additional training or knowledge, repair a broken mechanical control lever, examples including, but not limited to, a clutch or brake lever on a motorcycle or a brake release lever on machinery, while leaving the control lever in place within its holder/housing. The invention consists of a hollow cylindrical tube, open at one end and closed by a solid spherical ball at the other end, and raised ridges to improve the user's grip on the lever, designed to closely replicate the original shape and functionality of the broken control lever. The cylindrical tube is capable of holding the broken end of a control lever, and is of sufficient length, width, flexibility and tensile strength to form to the broken control lever and hold itself in place through friction and pressure.

### CROSS-REFERENCE TO RELATED APPLICATIONS

The application seeks priority to U.S. Provisional Patent Application No. 61/404,310 entitled “Control Lever Saver” filed on Oct. 1, 2010, the contents of which are hereby incorporated by reference.

### STATEMENT REGARDING FEDERALLY SPONSORED RESEARCH OR DEVELOPMENT

Not applicable

### BACKGROUND

Control levers on vehicles and mechanical equipment frequently break under use and/or in accidents, making the broken levers unsafe and unusable. Until now, the only way to correct this problem was to purchase and install new levers, an expensive and inconvenient proposition, or repair the broken levers through various welding or adhesive techniques. As control lever breakage is a common and frequent problem, resulting in significant down time and expense to industry and vehicle owners, a simple repair that requires no tools, special training or downtime to accomplish is advantageous.

Control levers on motorcycles, bicycles and scooters, consisting of brake and clutch levers, often break when the vehicle falls over, making the vehicle difficult, if not impossible, to drive safely and, in some instances, unable to pass inspection requirements, such as those in place at riding clinics, motorcycle safety classes, motorcycle track schools, and under racing conditions. Under such circumstances, the Control Lever Saver quickly and easily renders the vehicle control lever useable and able to pass inspection for continued use and/or training.

In industrial applications, broken control levers, such as, but not limited to, brake release levers, can result in expensive downtime required to restore equipment to safety specifications. Repair and replacement by outside suppliers and contractors add to the expense and parts delays can negatively impact productivity and profitability.

The Control Lever Saver is unique in that it is a means to make broken control levers useable and safe again without replacement or expensive repair and allows unskilled individuals to initiate and complete repairs in seconds. All that is required is for the user to simply press the Control Lever Saver onto the broken end of the control lever until such point that sufficient friction exists to hold the Control Lever Saver in place. No adhesives, bonding, welding or specialized hand tools are needed.

### SUMMARY OF THE INVENTION

The Control Lever Saver (“the invention”) offers an alternative to expensive replacement/repair of broken control levers, and is a device that can be used without training or special tools. The invention slides over the damaged control lever end, covering sharp, broken metal, and restores control lever length and functionality. It allows proper grip to be restored by means of raised ridges along the body of the device and a spherical closed end that replicates original lever design. The invention is comprised of any material that offers tensile strength and flexibility to allow the invention to form to a control lever's depth, width and height and, through friction, hold the invention in place.

### BRIEF DESCRIPTION OF THE DRAWINGS

FIG. 1 is a side view of Control Lever Saver, with open end facing to right and the front of invention facing upward to show raised ridges and closed end sphere orientation.

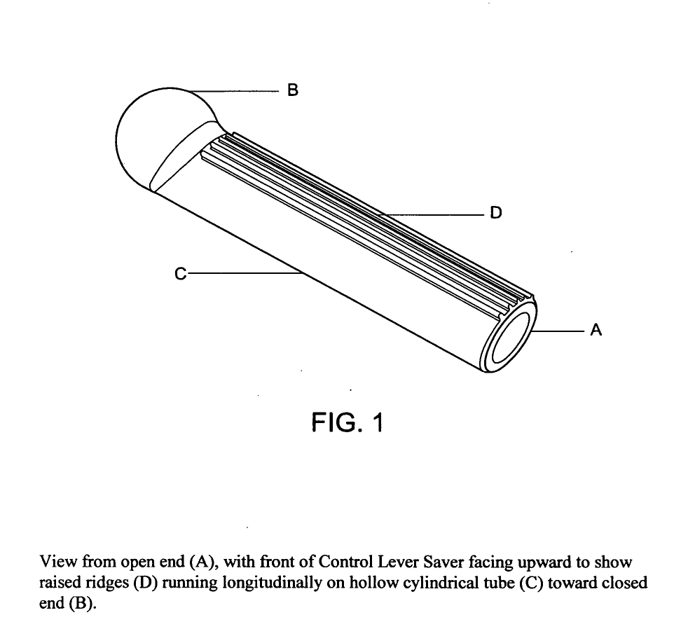

FIG. 2 is a top view of Control Lever Saver, with open end facing left and the front of the invention facing upward to show orientation of raised ridges and spherical closed end to body.

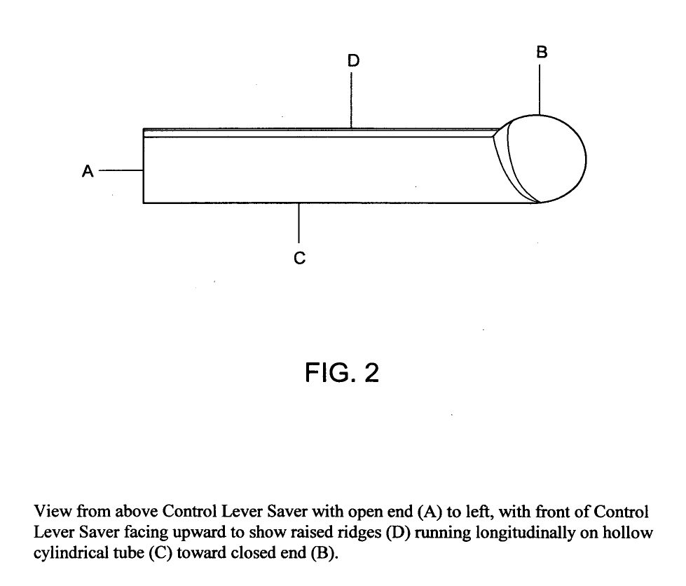

FIG. 3 is a side view of Control Lever Saver, with spherical closed end at lower left and open end of body at upper right with raised ridges facing upward to show placement, spacing and orientation of ridges and spherical closed end placement in relation to body.

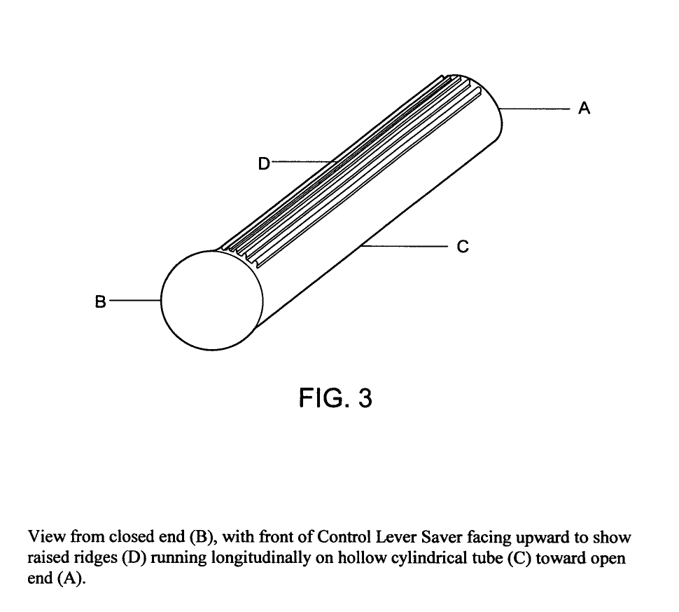

FIG. 4 is an end view of Control Lever Saver, with open end of body facing and closed spherical end at rear. Raised ridges face to the left to show spacing and placement.

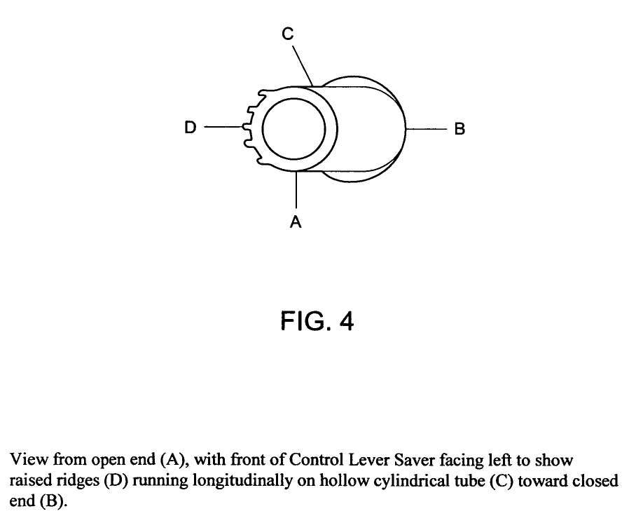

FIG. 5 is a detail of open end showing front of body facing upward, showing raised ridges in relation to body and spherical closed end to rear.

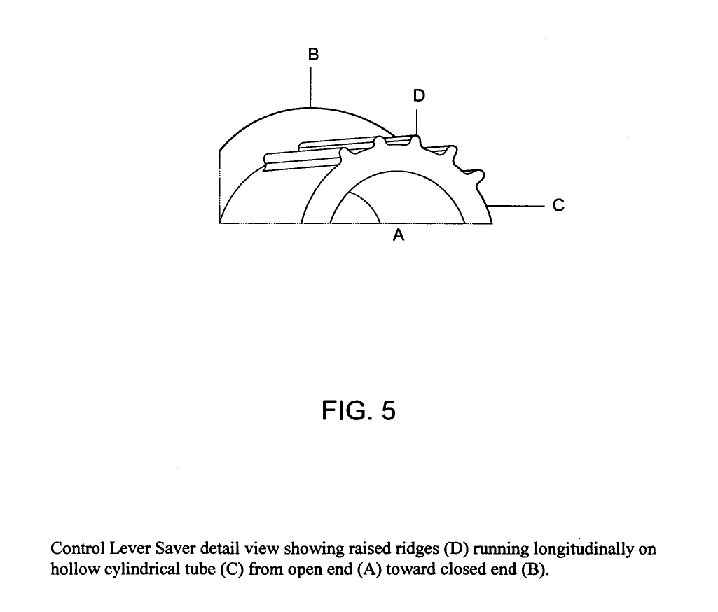

### DETAILED DESCRIPTION OF THE INVENTION

The Control Lever Saver is a simple cylindrical apparatus, open at one end and closed at the other by a solid sphere that is an integral part of the structure. The invention varies in length, diameter, height, depth and wall thickness according to the specific dimensions (length, width, height and depth) of the broken control lever it is designed to fit. The invention is comprised of any material that has sufficient flexibility and tensile strength to allow the Control Lever Saver to expand to fit around the intended specific broken control lever application and allow for continuous use under typical operating conditions. The Control Lever Saver is manufactured with materials that may include, but not be limited to, grades of polyethylene ranging from low-density to high-density, polyvinyl chloride, and natural or synthetic rubber, depending on the specific application and specifications required or specified by the user/customer. The invention is produced by way of injection molding, without seams, and may be produced in any color desired. Any number of raised ridges may be positioned along the front portion of the invention, with said ridges of varying height and width as necessary to provide the desired amount of grip specified by the customer/user.

The Control Lever Saver spherical ball end is of sufficient diameter to replicate the size of the original ball end of the control lever that the Control Lever Saver is designed for and intended to fit. Size may be increased or decreased according to user/customer requirements.

Use of the Control Lever Saver is accomplished by pressing the invention onto the broken end of the control lever for which it is specifically designed and intended, until such point as the combined length of the control lever and Control Lever Saver equals the original, unbroken length of the control lever to which the Control Lever Saver is applied. The Control Lever Saver flexes and expands to conform to the shape of the control lever, with said flexing and expanding resulting in sufficient friction and grip to hold the Control Lever Saver in place without additional adhesives.

What is claimed is:

1. A control lever saver, comprising: a body having a front; said body comprising a cylindrical tube with a substantially hollow interior section and one open end for access into said hollow interior, and a closed end consisting of a solid sphere, with said sphere positioned so that the rear of said sphere is in line with and level with the rear of said cylindrical tube, the front of said sphere projecting outward equidistantly from the front and sides of said body, with said body front having raised ridges extending outward from and positioned longitudinally along said body from said open end to said closed end sphere; said open end and said hollow interior of sufficient size and dimension to hold the broken end of a control lever and allow said control lever saver to be attached to said control lever, with said attachment consisting of the insertion of a broken control lever lengthwise into said hollow interior, and with no adhesives or additional materials necessary to hold said control lever saver in place on said control lever.
